(19) United States
(12) Patent Application Publication
(10) Pub. No.: US 2015/0180941 A1
(43) Pub. Date: Jun. 25, 2015

(54) Cloud Scene Sharing System

(71) Applicants: Chao-Tung Yang, Zhubei City (TW); Yi-Hsin Tsai, Zhubei City (TW)

(72) Inventors: Chao-Tung Yang, Zhubei City (TW); Yi-Hsin Tsai, Zhubei City (TW)

(21) Appl. No.: 14/134,821

(22) Filed: Dec. 19, 2013

(51) Int. Cl. H04L 29/08; H04L 29/06

(52) U.S. Cl. CPC H04L 67/10; H04L 63/10

(57) ABSTRACT

A cloud scene sharing system includes a first network device, a webcam device, and a second network device. The webcam device is provided for monitoring a scene of environment, wherein the first network device owns the initiative access privilege of the webcam device by means of a share master module. The share master module determines whether the initiative access privilege of the webcam device is to share with the second network device or not according to a relationship of network group configuration between the first network device and the second network device, wherein the first network device is operated to determine whether the initiative access privilege is to share with the second network device or not, wherein the network group configuration is provided for setting whether the first network device and the second network device are belonged to a same group or not.

### FIELD OF THE INVENTION

The present invention relates to a scene sharing system, and more particularly to a cloud scene sharing system that shares initiative access privilege of a webcam device according to a network group configuration.

### BACKGROUND OF THE INVENTION

Scene sharing system is operated to transfer digital scene information on line from on end to another, where the digital scene information includes digital photos and digital videos, so as to enable users to share scene with others. Scene sharing system provides the possibility that one remote users can view others' scene but is not able to download the digital scene, so that the remote users can easily watch the shared digital scene for any purpose, such as for security reason.

However, in the conventional scene sharing system, the initiative access privilege of a scene capturing devices, such a video camera, is only owned by one user, who is generally referred to as a master that possesses the whole privilege of the scene information. And the captured scene is watched and observed by the master by being uploaded to a network space. Because the necessity of waiting the capturing process and the uploading process operated by the master, other remote users is not allowed to watch the sharing digital scene in real time. Therefore, the conventional scene sharing system requiring the process of uploading does not meet the requirement for the situation that the real time sharing of the scene is desired.

Moreover, the master in the conventional scene sharing system requiring the uploading process generally only share the scene with others through a public manner or a privacy manner by selecting any other users for the sharing of the scene. The selecting operation is very complicated so that it decreases the efficiency of sharing of the scene.

### SUMMARY OF THE INVENTION

The present invention is for solving the disadvantages as above of the conventional scene sharing system.

Accordingly, an aspect of the present invention is to provide a cloud scene sharing system that shares initiative access privilege of a webcam device according to a network group configuration.

The cloud scene sharing system comprises a first network device, a webcam device, and a second network device. The first network device has a first displaying means. The webcam device has a network identification information, the webcam device is provided for monitoring a scene of environment and for transmitting a signal of the scene to the first displaying means of the first network device, wherein the first network device owns the initiative access privilege of the webcam device by means of a share master module. The second network device has a second displaying means, wherein the share master module determines whether the initiative access privilege of the webcam device of the first network device is to share with the second network device or not according to a relationship of network group configuration between the first network device and the second network device, wherein the first network device is operated to determine whether the initiative access privilege of the webcam device of the first network device is to share with the second network device or not, wherein the network group configuration is provided for setting whether the first network device and the second network device are belonged to a same group or not.

According to another aspect of the present invention, the network identification information is an internet protocol address.

According to another aspect of the present invention, the share master module is provided in the first network device.

According to another aspect of the present invention, it further comprises a social community network platform, wherein the network group configuration is set in the social community network platform.

According to another aspect of the present invention, the social community network platform includes an icon selecting element corresponding to the webcam device and the second network device.

According to another aspect of the present invention, the social community network platform executes a grouping operation to group a plurality of the icon selecting elements according to the network group configuration.

According to another aspect of the present invention, the social community network platform executes a grouping operation to group a plurality of the webcam devices according to the location relation between a plurality of the webcam devices.

According to another aspect of the present invention, the share master module further is preset to determine whether the initiative access privilege of the webcam device is to share with the second network device or not.

According to another aspect of the present invention, the share master module further includes a privacy configuration element being provided for determining whether the initiative access privilege is to be shared or not.

According to another aspect of the present invention, the second network device is installed with an account login module being provided for inputting an account identification information.

According to another aspect of the present invention, the share master module has a subgroup configuration element being provided for grouping a plurality of the second network devices.

According to another aspect of the present invention, the share master module further shares the initiative access privilege to a plurality of the second network devices according to a configuration result of the subgroup configuration element.

According to another aspect of the present invention, the share master module has a webcam group configuration element being provided for grouping a plurality of the webcam devices.

According to another aspect of the present invention, the share master module further is to share the initiative access privileges of a plurality of the webcam devices to the second network device according to a setting result of the webcam group configuration element.

According to another aspect of the present invention, it further comprises a configuration storing module that stores the network group configuration.

According to another aspect of the present invention, the configuration storing module is provided in a network server device connected to a network.

By means of the technology of the present invention, other users also can own the initiative access privilege that is shared with the master, so that other users can directly watch the scene captured by the webcam device instead of waiting the capturing process and the uploading process operated by the master. In this view, the immediacy of the scene sharing is increased and thus the cloud scene sharing system of the present invention is more suitable for certain situations, for example, the security monitoring situation. Furthermore, it is easy for the master to share the scenes with a plurality of other users belonging to a group to thus increase the efficiency of scene sharing. The easy operation of the clouding scene sharing system of the present invention, which is achieved by clicking icons on a social community network platform, is also advantageous. And it is convenient for the present invention to share the initiative access privilege of the webcam device with other users, and also will promote the share of the life joy as well.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is block diagram illustrating the cloud scene sharing system according to an embodiment of the present invention.

FIG. 2 is a schematic diagram illustrating the shared scenes according to an embodiment of the present invention.

FIG. 3 is an application diagram illustrating the cloud scene sharing system according to an embodiment of the present invention.

FIG. 4 is a schematic diagram illustrating a share master page of the social community network platform according to an embodiment of the present invention.

FIG. 5 is a schematic diagram illustrating the scenes displayed on each network device according an embodiment of the present invention.

FIG. 6 is a schematic diagram illustrating the second network device subgroups according to another embodiment of the present invention.

FIG. 7 is a schematic diagram illustrating the webcam groups according to another embodiment of the present invention.

### DETAILED DESCRIPTION OF THE PREFERRED EMBODIMENTS

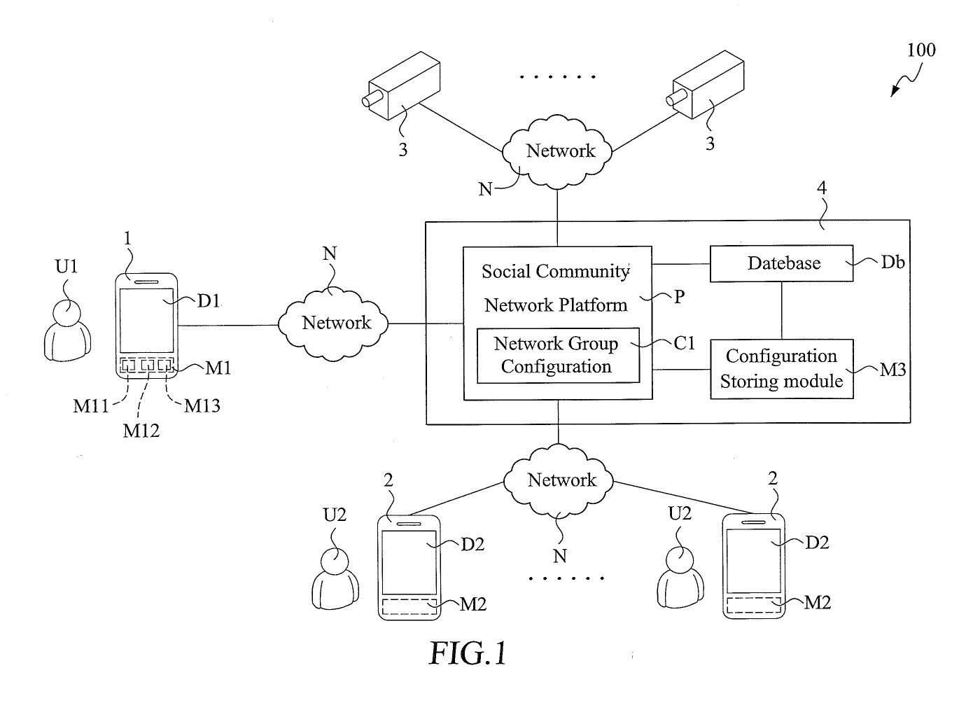

Refer to FIG. 1. The cloud scene sharing system 100 includes a first network device 1, a second network device 2, a webcam device 3, and a network server device 4. And the first network device 1, the second network device 2, the webcam device 3, and the network server device 4 are connected with each others via a network N.

The first network device 1 and the second network device 2 can be mobile devices or computers, but not limits to these. The first network device 1 has a first displaying means D1, such as a monitor screen of the first network device 1. The second network device 2 has a second displaying means D2, such as a monitor screen of the second network device 2.

The webcam device 3 is provided for monitoring a scene of environment and for transmitting a signal of the scene to the first displaying means D1 of the first network device 1 via the network N. And the webcam device 3 has a network identification information. In this embodiment, the network identification information is a fixed IP (internet protocol) address.

The network server device 4 is provided with a database Db. The identification information of the first network device 1, the identification information of the second network device 2, and the network identification information of the webcam device 3 are stored in the database Db. The identification information of the first network device 1 and that of the second network device 2 are registration information that are received, through the network N, by the registration of the user U1, U2, respectively. However, the present invention is not limited to this. The identification information also can be an IP address of the first network device 1 or of the second network device 2.

And the network server device 4 is provided with a social community network platform P connected with the database Db. In this embodiment, the second network device 2 is installed with an account login module M2 provided for inputting an account identification information to login to the social community network platform P. In this embodiment, the account login module M2 is an APP (Application software) program module. However, the present invention is not limited to these. In other embodiments, the account login module M2 also can be an APP program module installed in the first network device 1 or a module installed in the network server device 4, such as a login page of the social community network platform P. By means of the social community network platform P, it enables the first network device 1, the second network device 2, and the webcam device 3 to selectively communicate with each other. And by means of the social community network platform P, it also enables the first network device 1, the second network device 2, and the webcam device 3 to be organized as a group, referring to as grouping or group. In detail, a network group configuration C1 is provided in the community network platform P for setting whether the first network device 1 and the second network device 2 are belonged to the same group or not. And the setting result of the network group configuration C1 is stored in the database Db by a configuration storing module M3 in the network server device 4.

A share master module M1 is provided in the first network device 1. In this embodiment, the share master module M1 is an APP (Application software) installed in the first network device 1, and thus the user U1 can directly change the network group configuration C1 by operating the share master module M1 on the first network device 1. However, the present invention is not limited to these. In other embodiments, the share master module M1 also can be a program module installed in the network server device 4, such as a program module embedded in the social community network platform P. By means of the share master module M1, it enables the first network device 1 to own the initiative access privilege of the webcam device 3, and the initiative access privilege of the webcam device 3 owned by the first network device 1 is determined to share with the second network device 2 or not according to a relationship of the network group configuration C1 between the first network device 1 and the second network device 2 by operating the first network device 1.

In a preferred embodiment, the share master module M1 is further provided with a privacy configuration element M11, a subgroup configuration element M12, a webcam group configuration element M13 for executing various actions that will be described in detail by the followings.

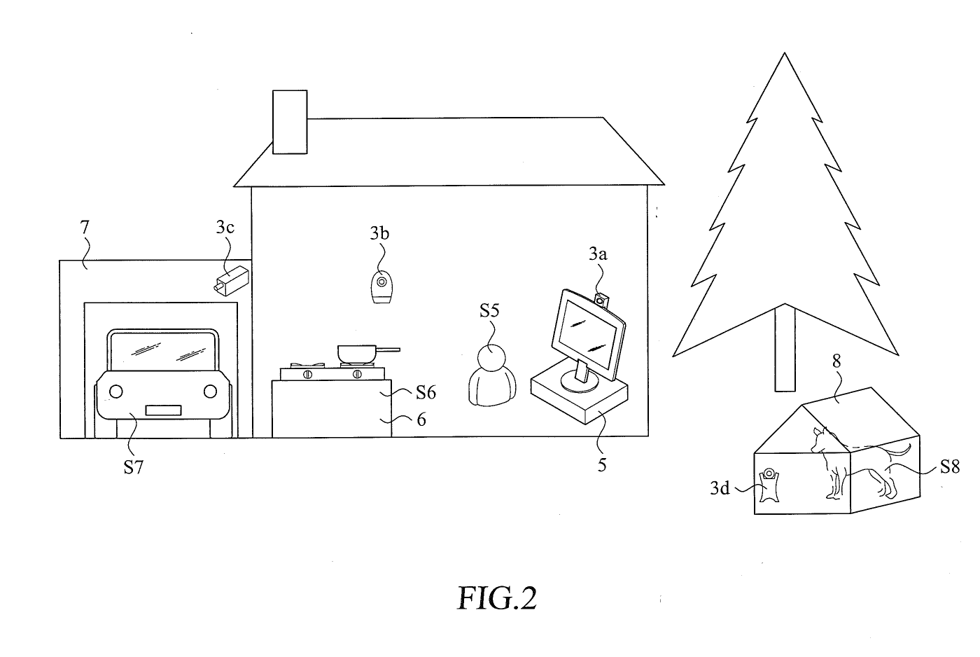

Also refer to FIG. 2 to FIG. 5, the application of the cloud scene sharing system 100 will be described more specifically as follows:

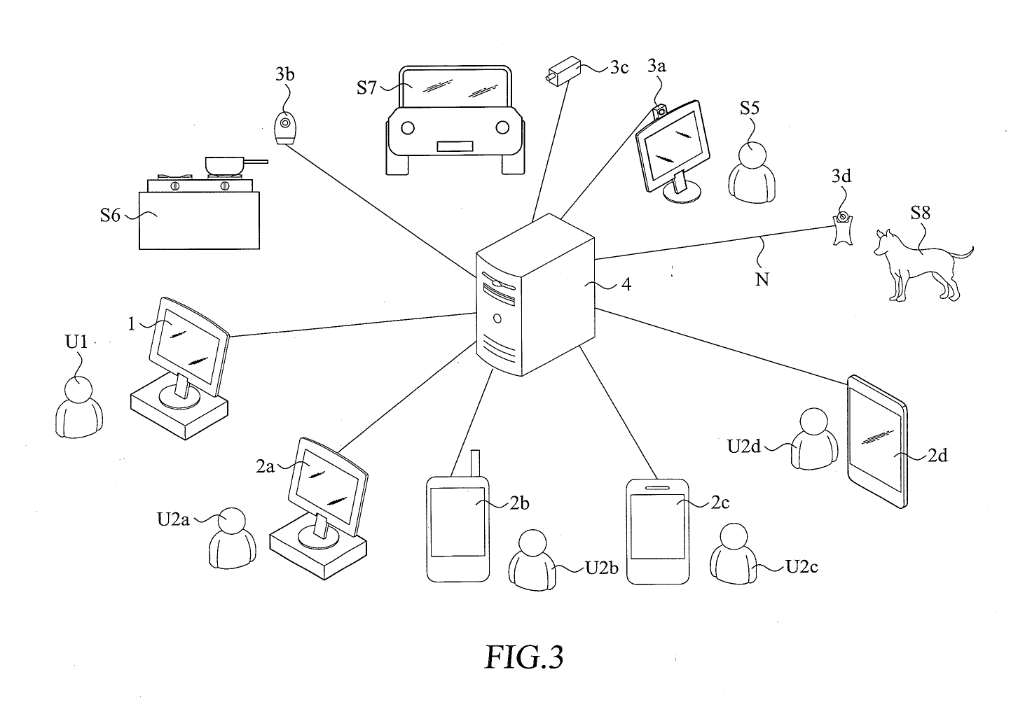

As shown in FIG. 2, FIG. 2 is a schematic diagram illustrating the shared scenes according to an embodiment of the present invention. In this embodiment, scenes monitored and captured by various webcam devices in a house are taken for example. A webcam device 3a is provided on a computer 5 for monitoring a scene of a computer user S5. A webcam device 3b is provided in a kitchen 6 for monitoring a scene of a gas stove S6. A webcam device 3c is provided in a garage 7 for monitoring a scene of a car S7. A webcam device 3d is provided in a doghouse 8 for monitoring a scene of a dog S8. The webcam device 3a, 3b, 3c, 3d are connected with the network server device 4 via the network N, and the network server device 4 are connected with the first network device 1 and the second network devices 2a, 2b, 2c, 2d via the network N, as shown in FIG. 3.

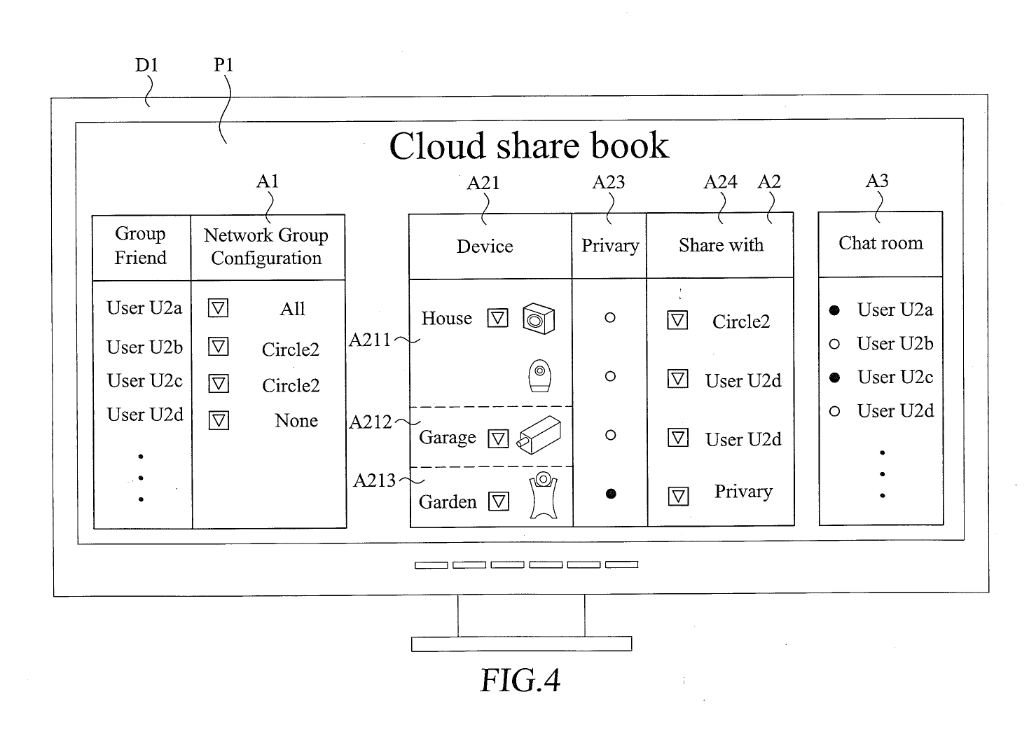

As shown in FIG. 4, FIG. 4 is a schematic diagram illustrating a share master page of the social community network platform according to the embodiment of the present invention. By means of the share master module M1, a share master page P1 of the social community network platform P can be displayed on the first displaying means D1 of the first network device 1. A plurality of the icon selecting elements is respectively corresponding to the webcam devices 3a, 3b, 3c, 3d and the Users U2a, U2b, U2b, U2c respectively corresponding to second network devices 2a, 2b, 2c, 2d.

A group configuration area A1 of the share master page P1 is provided for the User U1 to execute the network group configuration to determine which groups that the Users U2a, U2b, U2b, U2c are belonged to. After executing the network group configuration, the social community network platform P will execute a grouping operation to group a plurality of the icon selecting elements according to the network group configuration.

A scene sharing configuration area A2 of the share master page P1 is provided for the User U1 to determine whether the initiative access privilege of the webcam device 2a, 2b, 2c, 2d is to share with the second network device 2a, 2b, 2c, 2d or not. In a device selecting subarea A21 of the scene sharing configuration area A2, since the social community network platform P executes a grouping operation to group a plurality of the webcam devices 3a, 3b, 3c, 3d according to the location relation between a plurality of the webcam devices 3a, 3b, 3c, 3d, the icon selecting elements of the webcam device 3a, 3b are shown in a house area A211, the icon selecting element of the webcam device 3c is shown in a garage area A212, and the icon selecting element of the webcam device 3d is shown in a garden area A213. In a privacy selecting subarea A23, by means of the privacy configuration element M11 of the share master module M1, the initiative access privilege of the webcam device 3a, 3b, 3c, 3d can be determined to be shared or not, wherein the initiative access privilege of the webcam device 3a, 3b, 3c, 3d is preset to not to share with the second network device 2a, 2b, 2c, 2d. However, the present invention is not limited to this, the initiative access privilege of the webcam device 3a, 3b, 3c, 23d also can be preset to share with the second network device 2a, 2b, 2c, 2d. In a share selecting subarea A24, the initiative access privilege of the webcam device 3a, 3b, 3c, 3d can be respectively determined which of the network group is selected for being shared. In addition, a chat room area A3 of the share master page P1 is provided for all users U1, U2a, U2b, U2b, U2d to communicate with each other in the social community network platform P.

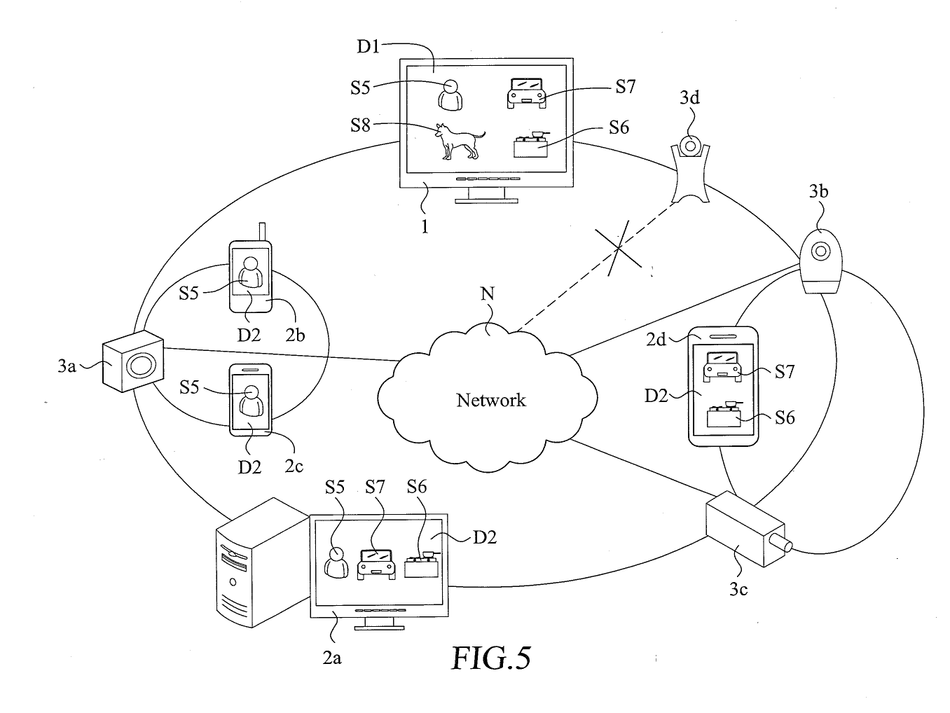

As shown in FIG. 5, FIG. 5 is a schematic diagram illustrating the scenes displayed on each network device according the setting result in the scene sharing configuration area A2.

Since the first network device 1 owns the original initiative access privilege of the webcam devices 3a, 3b, 3c, 3d by means of the share master module M1, all the scenes S5, S6, S7, S8 can be displayed on the first displaying means D1 of the first network device 1. Since the initiative access privilege of the webcam device 3d is set as privacy in the privacy selecting subarea A23, the scenes S8 can not be displayed on all of the second displaying means D2 of the second network device 2a, 2b, 2c, 2d. Even the user U2a and the User 1 are belonged to the same circle, the scenes S8 still can not be displayed on the second displaying means D2 of the second network device 2a of user U2a. Since the circle2 is set to own the initiative access privilege of the webcam device 3a in the share selecting subarea A24, so the second displaying means D2 of the second network device 2b, 2c, of which users are the members of the circle2, can display the scene S5 monitored by the webcam device 3a. And since the initiative access privilege of the webcam device 3b, 3c both are set to share with the User 2d, the second displaying means D2 of the second network device 2d can display both the scenes S6, S7 monitored by the webcam device 3b, 3c.

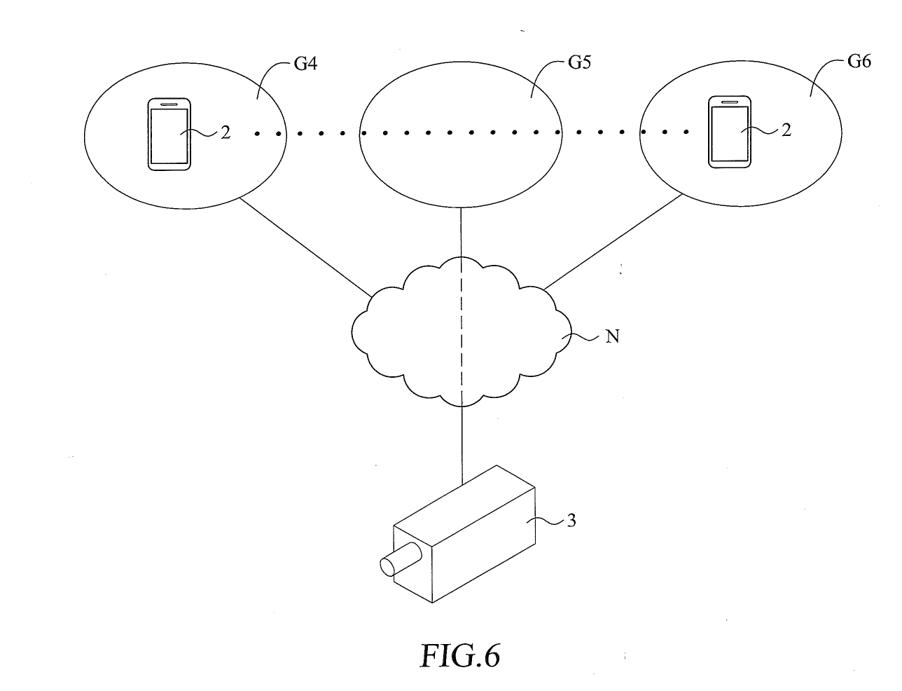

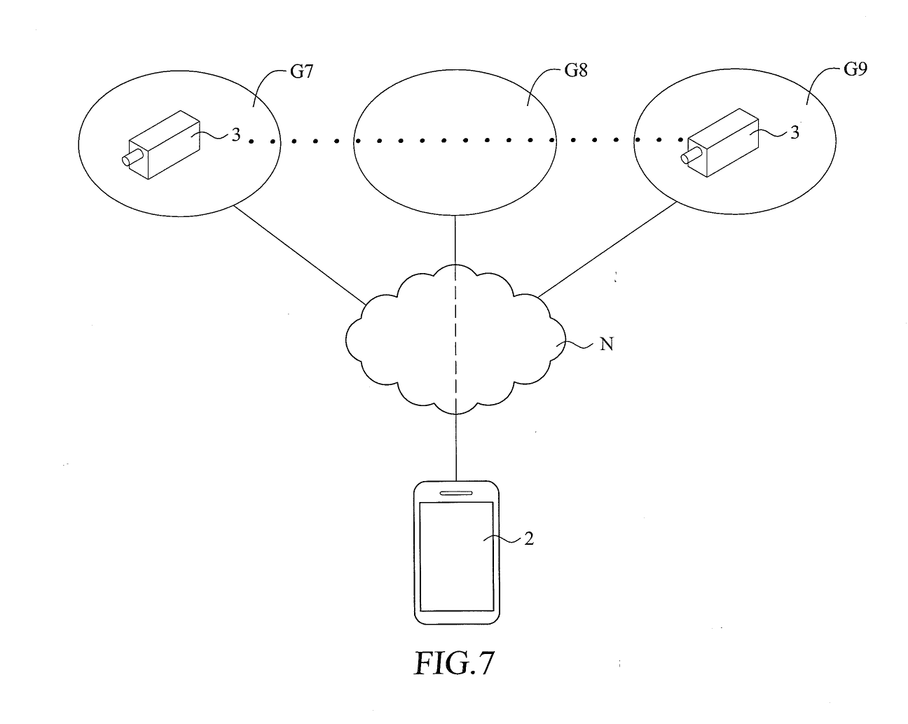

Refer to FIGS. 6-7 and also refer to FIG. 1. FIG. 6 is a schematic diagram illustrating the second network device subgroups according to another embodiment of the present invention. FIG. 7 is a schematic diagram illustrating the webcam groups according to another embodiment of the present invention. As shown in FIG. 6, by means of the subgroup configuration element M12 of the share master module M1, there is a plurality of the second network devices 2 being grouped into second network device subgroup G4, G5, and G6. And the share master module M1 further shares the initiative access privilege to a plurality of the second network devices 2 according to a configuration result of the subgroup configuration element M12, so that a plurality of the second network devices 2 belonging to the Group G5 owns the initiative access privilege of the webcam device 3.

As shown in FIG. 7, by means of the webcam group configuration element M13 of the share master module M1, there is a plurality of the webcam devices 3 being grouped into webcam group G7, G8, and G9. And the share master module M1 further is to share the initiative access privilege of a plurality of the webcam devices 3 to the second network device 2 according to a setting result of the webcam group configuration element M13, so that the initiative access privileges of a plurality of the webcam device 3 belonging to the Group G8 are owned by the second network device 2.

The above description should be considered as only the discussion of the preferred embodiments of the present invention. However, a person skilled in the art may make various modifications to the present invention. However, those modifications still fall within the spirit and scope defined by the appended claims.

What is claimed is:

1. A cloud scene sharing system, comprising:
a first network device having a first displaying means;
a webcam device having a network identification information, the webcam device being provided for monitoring a scene of environment and for transmitting a signal of the scene to the first displaying means of the first network device, wherein the first network device owns the initiative access privilege of the webcam device by means of a share master module; and
a second network device having a second displaying means, wherein the share master module determines whether the initiative access privilege of the webcam device of the first network device is to share with the second network device or not according to a relationship of network group configuration between the first network device and the second network device,
wherein the first network device is operated to determine whether the initiative access privilege of the webcam device of the first network device is to share with the second network device or not,
wherein the network group configuration is provided for setting whether the first network device and the second network device are belonged to a same group or not.

2. The cloud scene sharing system as claimed in claim 1, wherein the network identification information is an internet protocol address.

3. The cloud scene sharing system as claimed in claim 1, wherein the share master module is provided in the first network device.

4. The cloud scene sharing system as claimed in claim 1, further comprising a social community network platform, wherein the network group configuration is set in the social community network platform.

5. The cloud scene sharing system as claimed in claim 4, wherein the social community network platform includes an icon selecting element corresponding to the webcam device and the second network device.

6. The cloud scene sharing system as claimed in claim 4, wherein the social community network platform executes a grouping operation to group a plurality of the icon selecting elements according to the network group configuration.

7. The cloud scene sharing system as claimed in claim 4, wherein the social community network platform executes a grouping operation to group a plurality of the webcam devices according to the location relation between a plurality of the webcam devices.

8. The cloud scene sharing system as claimed in claim 1, wherein the share master module further is preset to determine whether the initiative access privilege of the webcam device is to share with the second network device or not.

9. The cloud scene sharing system as claimed in claim 1, wherein the share master module further includes a privacy configuration element being provided for determining whether the initiative access privilege is to be shared or not.

10. The cloud scene sharing system as claimed in claim 1, wherein the second network device is installed with an account login module being provided for inputting an account identification information.

11. The cloud scene sharing system as claimed in claim 1, wherein the share master module has a subgroup configuration element being provided for grouping a plurality of the second network devices.

12. The cloud scene sharing system as claimed in claim 11, wherein the share master module further shares the initiative access privilege to a plurality of the second network devices according to a configuration result of the subgroup configuration element.

13. The cloud scene sharing system as claimed in claim 1, wherein the share master module has a webcam group configuration element being provided for grouping a plurality of the webcam devices.

14. The cloud scene sharing system as claimed in claim 13, wherein the share master module further is to share the initiative access privileges of a plurality of the webcam devices to the second network device according to a setting result of the webcam group configuration element.

15. The cloud scene sharing system as claimed in claim 1, further comprising a configuration storing module that stores the network group configuration.

16. The cloud scene sharing system as claimed in claim 15, wherein the configuration storing module is provided in a network server device connected to a network.
